(19) United States
(12) Patent Application Publication
(10) Pub. No.: US 2005/0135613 A1
(43) Pub. Date: Jun. 23, 2005

(54) Device and method for generating encrypted data, for decrypting encrypted data and for generating re-signed data

(76) Inventors: Karlheinz Brandenburg, Erlangen (DE); Christian Neubauer, Nuernberg (DE); Ralph Kulessa, Feucht (DE); Frank Siebenharr, Nuernberg (DE); Wolfgang Spinnler, Erlengen (DE)

Correspondence Address: GLENN PATENT GROUP, 3475 EDISON WAY, SUITE L, MENLO PARK, CA, 94025, US

(21) Appl. No.: 10/985,479

(22) Filed: Nov. 10, 2004

Related U.S. Application Data
(63) Continuation of application No. PCT/EP03/04735, filed on May 6, 2003.

(30) Foreign Application Priority Data
May 10, 2002 (DE) 10220925.1-13

(51) Int. Cl. H04L 9/00

(52) U.S. Cl. 380/43

(57) ABSTRACT

Devices and methods for generating encrypted data, for playing encrypted data and for re-signing originally signed encrypted data are based on the encrypted data, apart from the encrypted media information, to include the information required for decrypting the data and additionally a signature of who has generated the encrypted data. Thus the origin of the encrypted data can be traced back. In particular, passing on the encrypted data to a limited extent by the producer of the *encrypted data, for example to friends or acquaintances, is allowed, while only a mass reproduction of the encrypted data is considered as pirate copying. The pirate copier can, however, be found out with the help of the signature, wherein the signature is optionally protected by an embedded watermark signature. Because this is a concept wherein, when being used legally, only encrypted data occur, the unauthorized removal of the encryption is a statutory offence. The inventive concept makes possible finding the offender and at the same time considers ownerships of the operators with regard to a limited passing-on of media information, and thus has the potential of being accepted on the market.

### CROSS-REFERENCE TO RELATED APPLICATION

This application is a continuation of copending International Application No. PCT/EP03/04735, filed May 6, 2003, which designated the United States and was not published in English, and is incorporated herein by reference in its entirety.

### BACKGROUND OF THE INVENTION

1. Field of the Invention

The present invention relates to media distribution and, in particular, to a distribution of media which allows a cost-free passing-on on a moderate scale, which, however, makes passing-on on a large scale at least difficult and in any case traceable.

2. Description of the Related Art

The digital signal representation for media contents has made it possible to copy media contents as often as wanted without a quality loss. This has resulted in an increase in unauthorized copying, i.e. “pirate copying”, compared to some years ago, resulting in financial losses for the proprietors of the rights of media contents. Compared to some years ago when analog signal representation was predominant and when the quality characteristic was a motivation, for example, to buy a record and not only to own a pirate copy, the possibility of digital media reproduction has resulted in an ever-increasing financial loss of the proprietors of rights.

As a response to this situation, there are different concepts, of which one is known under the keyword “SDMI”, and companies such as, for example, Intertrust, trying by means of cryptographic methods to prevent the access for unauthorized operators. This, however, means increased cost on the one hand and a clipping of up-to-now usual ownerships of the operators on the other hand. Such usual ownerships of the operators have always been to distribute a certain small number of private copies to friends or family.

Prior art cryptographic methods suffer from the following disadvantages. Firstly, a complex logistic distribution of the access keys must be put up with. In addition, prior art formats additionally require a separate decoding key which must be provided separately from the media contents by an alternative way, such as, for example, by mail, telephone, etc. If this separate decoding key is no longer available, if, for example, a system change has taken place or a usage contract has expired, the music collection, for example, in this protected format will become useless. Such a format is not safe for the future and quickly becomes obsolete. Furthermore, private copies for friends, such as, for example, recording a CD to an audio cassette or recording a CD to an audio cassette to be able to play it, for example, in a car, are not possible since existing rights are either only tied to apparatus or persons and thus cannot be applied or extended to other apparatus or persons.

In addition, such systems have always provided a stimulus to crack the cryptographic protection concept because any access except for the authorized access is prevented.

Furthermore, such cryptographic protection concepts have often relied on cryptographic safeguarding. In cracked methods, the contents has then been completely free and without a remark to anyone in the (illegal) distribution chain. Thus, such an offence could not been proven.

Systems trying to limit the financial damage for the proprietors of the media contents, for example in audio work of music industry, are referred to as “DRM systems” (DRM=Digital Rights Management) among experts. Such systems are to prevent unauthorized copying and to make possible detailed accounting preferably via “E-Commerce” methods. Such systems, however, still have not yet become established and the acceptance on the side of the operator is still questionable since, as has been explained, existing ownerships of the operators will be limited.

It is common to all those methods that they prevent access to the contents for unauthorized persons and that authorized persons usually have to pay. This payment can, by means of appended rules, be adjusted very precisely to the actual usage, which is at least fairer than general payments for the apparatus or data carrier. Such rules which, for example, state that, for example, seven copies of the original are allowed, but that a copy of the copy is not allowed, etc., are, however, complex and, due to this complexity, are also doubtful as to acceptance by the operator.

Current systems are, for example, described in “Secure Delivery of Compressed Audio by Compatible Bitstream Scrambling”, C. Neubauer and J. Herre, Preprint 5100, 108^{th} AES Convention, Paris, February 2000. In addition, reference is made to Jack Lacy, Niels Rump, Talal Shamoon, Panos Kudumakis, “MPEG-4 Intellectual Property Management & Protection (IPMP) Overview & Applications”, 17^{th} AES Conference, Florence, September 1999, or to Niels Rump, Philip R. Wiser, “AESSC SC-06-04 Activities on Digital Music Distribution”, 17^{th} AES Conference, Florence, September 1999.

As has already been explained, all the disadvantages mentioned above result in the acceptance by the operator being low so that well-known systems may not be accepted on the market. This might be due to the fact that, up to now, they have solely been adjusted to the interest of the music industry and not so much to “ownership” of existing operators, which, according to the letters of the law, may be illegal but, when being infringed on, might automatically result in a defeat of such a system.

### SUMMARY OF THE INVENTION

It is the object of the present invention to provide a rights management concept having a better chance of being accepted on the market.

In accordance with a first aspect, the present invention provides a device for generating encrypted data representing media information, having: means for providing an operator identification by means of which an operator of the device can be identified; means for encrypting the media information with an encrypting key to generate encrypted media information; and means for adding additional information to the encrypted media information to generate the encrypted data, the additional information including the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text or the key in plain text.

In accordance with a second aspect, the present invention provides a method for generating encrypted data representing media information, having the following steps: providing the operator identification by means of which an operator of the device can be identified; encrypting the media information with an encrypting key to generate encrypted media information; and adding additional information to the encrypted media information to generate the encrypted data, the additional information including the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text of the key in plain text.

In accordance with a third aspect, the present invention provides a device for decrypting encrypted data representing media information, the encrypted data having encrypted media information and additional information, wherein the additional information include the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text of the key in plain text, having: means for extracting the encrypting key in plain text of the key in plain text as the decrypting key from the encrypted data; means for decrypting the encrypted media information using the decrypting key to obtain decrypted media information; and means for playing the media information, wherein the device is further configured to prevent an output of the decrypted media information as digital data.

In accordance with a fourth aspect, the present invention provides a method for decrypting encrypted data representing media information, the encrypted data having encrypted media information and additional information, the additional information including the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text of the key in plain text, the method having the following steps: extracting the encrypting key in plain text or the key in plain text as the decrypting key from the encrypted data; decrypting the encrypted media information using the decrypting key to obtain decrypted media information; playing the media information; and preventing an output of the decrypted media information as digital data.

In accordance with a fifth aspect, the present invention provides a device for generating re-signed data from encrypted data already signed, representing media information, the encrypted data having encrypted media information and additional information, wherein the additional information includes the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text or the key in plain text, having; means for providing a re-signing operator identification of an operator of the device for generating the re-signed data; means for extracting the encrypting key in plain text or the key in plain text as decrypting information from the encrypted data; means for decrypting the media information using the decrypting information to obtain decrypted media information; means for encrypting again the decrypted media information using a new encrypting key corresponding to the re-signing operator identification or being derived therefrom in order to obtain media information encrypted again; and means for adding the re-signing operator identification to the media information encrypted again in order to obtain the re-signed data.

In accordance with a sixth aspect, the present invention provides a method for generating re-signed data from encrypted data already signed, representing media information, the encrypted data having encrypted media information and additional information, wherein the additional information includes the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text or the key in plain text, having the following steps: providing a re-signing operator identification of an operator of the device for generating re-signed data; extracting the encrypting key in plain text of the key in plain text as decrypting information from the encrypted data; decrypting the media information using the decrypting information to obtain decrypted media information; encrypting again the decrypted media information using a new encrypting key corresponding to the re-signing operator identification or being derived from same in order to obtain again encrypted media information; and adding the re-signing operator identification to the media information encrypted again in order to obtain the re-signed data.

In accordance with a seventh aspect, the present invention provides a computer program having a program code for performing one of the above-mentioned methods when the computer program runs on a computer.

The present invention is based on the finding that only a rights management concept will be accepted on the market, which not only considers the interest of the music industry but also the already existing ownerships or interests of the operators which in the end will be responsible for the acceptance on the market. Put differently, the inventive concept for media distribution provides a trade-off between the interest of media providers and media consumers.

The present invention, as will be illustrated subsequently referring to different aspects, is based on the idea that contents, once bought, in principle is made available for anybody. An identification of the first buyer, however, or of the person passing on the media contents is contained in the data passed on. In this way, a prosecution of the offender and a punishment of the offense are possible in the case of abuse when, for example, an immensely large number of copies is made, because the offender can be identified by means of the copies distributed in masses.

Encrypted data produced according to the invention is particularly characterized in that it is encrypted, but that it contains decrypting information and that it additionally contains identification information of the person having generated the encrypted data. The encrypted data thus includes, apart from the encrypted media information, additional information designed such that both an identification of the generator of the encrypted data and a decryption of the encrypted media information with the help of the additional information can be performed.

Put differently, this means that the publisher of media contents has to sign the contents digitally before publishing it.

An essential aspect of the inventive concept is the fact that it is based on encryption, i.e. the media contents or media information is encrypted. An elimination of the encryption is an illegal act under the relevant law of the United States known as the “Milleniums Act”. In this context, it is pointed out that copying unencrypted files, such as, for example, MP3 files, is not an offense according to the law of the United States, but the unauthorized elimination of an encryption is an offense.

In a preferred embodiment of the present invention, the identification information on the one hand and the decryption information on the other hand, which are both part of the encrypted data, are dependent on each other. This ensures that a removal of the identification information from the encrypted data has the result that the encrypted data can no longer be decrypted. In a preferred embodiment of the present invention, an asymmetrical encrypting method is employed here. In particular, an operator has a pair associated to him consisting of a public key and a private key. The private key is used by an operator to encrypt a symmetrical key for decrypting the media information to obtain an encrypted symmetrical key. The operator then adds this encrypted symmetrical key and its public key to the encrypted media information. In this case, the added public key is the operator identification, since the operator can be identified unambiguously with the help of this public key. A recipient of the encrypted data will then extract the public key from the encrypted data, decrypt the added encrypted symmetrical key with this public key and then decrypt and finally play the encrypted media information using the decrypted symmetrical key. If the public key of the generator of the encrypted data is removed without permission, a decryption of the symmetrical key and finally a decryption of the encrypted media information will no longer be possible. Thus, the operator identification information (signature) is responsible for the encrypted data to be useful or not.

It is to be mentioned that a free distribution of the media information to a limited extent, i.e. among friends or acquaintances or for different players of the operator itself, is free. Thus, the usual ownerships of the operators who will probably not accept such ownerships to be cut, are taken into consideration. In the end, this could be the decisive factor for the inventive concept to become accepted on the market. On the other hand, the interests of the proprietors of the rights of the media information are considered in that they have to put up with a limited cost-free reproduction—like in the times of analog audio representation—but that they have the possibility to trace and punish gross misuse, such as, for example, providing the media information on a large scale, for example via the Internet. The tracing is made possible by the fact that the encrypted data to be decryptable contains the identification of the person having performed the distribution on a large—unauthorized—scale.

In a preferred embodiment of the present invention, it is also preferred, so to speak as a second line of defense, to add a watermark which is also to make possible an operator identification apart from the plain text operator identifications to the media information. If the attacker should succeed in tampering with or removing the operator identification and nevertheless provide an intact data stream, its identification is still possible with the help of the watermark. In particular in the case in which an attacker succeeds in generating plain text data from the encrypted data, which, however, is made difficult by technological precautions, an identification can still be found out by means of the watermark. If he should succeed in generating plain text data without his watermark to be added to the media information, a watermark of the person having provided the offender with the encrypted data will be contained in the media information. Thus, at least this identity can be obtained. There is at least a chance to find out the actual offender who, due to the fact that he has removed an encryption, has acted illegally and has thus committed an offense, as has been explained above.

The inventive concept is thus characterized in that it contains the media information in an encrypted form and in that the key for decoding and playing is contained in the encrypted data, wherein, however, there is no legal possibility to write a file with plain text data. Additionally, the encrypted data contains the operator identity as a digital certificate or a user signature in a protected way. Preferably, this signature is issued and registered by a certifying authority, so that an operator identification can also be used in court in the case of a punishment. In addition, it is preferred as a second line of defense to inscribe the operator identity into the media data as a watermark.

The inventive concept is of advantage for the operators or consumers of media information in that a transparent system is provided, which is simple to use and allows free copying for private usage (such as, for example, for friends), i.e. to a limited extent. Simple operators who, up to now, have been in a state of semi-legality and who do not have illegal interests are thus—with a corresponding situation of the laws or regulations of the media providers—raised to a legal state. Additionally, it is preferred to compress the media information before encrypting it for a data rate compression. When MPEG-4 is employed as a compression method, the operator will even obtain a better audio quality and a higher compression than with, for example, MP3 and is thus motivated to switch from the MP3 format which can be copied freely in every respect to MPEG-4 which, by means of the inventive concept, becomes an encrypted method. No disadvantages arise for the normal operator who still wants to copy freely on a small scale, by the new concept, but do arise for illegal traders producing pirate copies on a large scale. This pirate copying is not prevented completely by the encrypted concept, the pirate copier, however, can be found out and punished with the help of the operator identification in the encrypted data.

In addition, the operator receives additional media tracks, in particular, as MPEG-4 is not only an audio compression method but can also be used for video, text, etc. All in all, it is thought that illegal copying can be reduced by virtue of the inventive concept so that, for example, the prices for music and video work will decrease due to the decreased illegal usage.

The inventive concept is also of advantage for the proprietors of the rights of media information in that this is not a deterioration compared to the times of analog music distribution, but provides legal grounds for putting a stop to the widespread pirate copying in the age of MP3.

Additionally, this system, for the media producers, provides entry to an age in which media contents is no longer distributed freely, but in an encrypted form. Additionally, the inventive concept is of advantage to the music industry in that it has the effect that the operators appreciate the value of the media information, already due to the fact that it is encrypted. In addition, the inventive concept will result in operators to deal with media contents in a more responsible way, since they have to expect, when passing on the media, that in the end their identity will be contained in a pirate copy distributed in masses, which might cause difficulties. The operator acceptance should, however, not suffer from this since passing-on on a limited scale will be raised from the state of semi-legality to a legal state.

The inventive concept additionally solves several problems of prior art DRM systems by adding the decoding key so that a complicated key management, which is expensive in logistics, is not required. In addition, the inventive concept is self-contained, which, put differently, means that the encrypted data, for all times, contains the information required for playing, which is how encrypted data generated according to the invention is save for the future. The encrypting methods used, such as, for example, RSA as an example of an asymmetrical encrypting method, and Rijndal as an example of a symmetrical encrypting method, are also public.

The inventive concept, as has been the case up to now, allows copying and playing within an area of responsibility of the operator at will, i.e. also passing on to friends in the private sector, i.e. to a limited extent.

Additionally, the inventive concept does not pose a stimulus for “cracking” for the normal operator, since the access is free anyway. The responsibility of the operator will limit the distribution in masses, but not so a cryptographic method.

Additionally, a watermark which so to speak as an optional additional line of defense identifies the signer is optionally contained in cracked media data.

In addition, the inventive concept is independent of the source encoding format used. Every compressing method existing up to now, such as, for example, MP3 etc., can be integrated, even though it is preferred to employ the new MPEG-4 method as the source encoding method to give operators an additional stimulus, since MPEG-4 contains higher data rate compressions and better audio/video qualities and further improved features. This stimulus for the operator to agree to the inventive concept, can be increased further by no longer making MPEG-4 encoders/decoders available for free, but being only available for free or at a low price in connection with the DRM system in order not to put the introduction on the market at risk. This means that in the best case there are no decoders and, in particular, hardware players playing the unencrypted format. This has the result that it is easier for a normal operator not having illegal intentions to download and use the new—encrypted and signed—format than to perform complicated attacks on the cryptographic protection or the signature.

### BRIEF DESCRIPTION OF THE DRAWINGS

Preferred embodiments of the present invention will be detailed subsequently referring to the appended drawings, in which:

FIG. 1 shows a block diagram of the inventive concept for generating encrypted data;

FIG. 2 shows a block diagram of the inventive concept for decrypting/playing encrypted and signed data;

FIG. 3 shows a block diagram of the inventive concept for re-signing encrypted data to allow passing it on to other—trustworthy—persons;

FIG. 4 shows a schematic illustration of the format of encrypted and signed media information;

FIG. 5 shows an overview of the scenario and the different data formats which can be served by the inventive concept in its instances;

FIG. 6 shows a block diagram of a simple device for playing encrypted and signed media information;

FIG. 7 shows a block diagram of an inventive device for generating an operator-specific local archive as an “introductory version”;

FIG. 8 shows a block diagram of an inventive device for playing, generating and re-signing according to a preferred embodiment of the present invention;

FIG. 9 shows an extension of the device of FIG. 8 to publish media information especially provided by a media provider in an encrypted and signed format; and

FIG. 10 shows an extension of the device of FIG. 9 to make possible, apart from the free encrypted/signed option, a point-to-point option, in which passing on contents to other people is not possible.

### DESCRIPTION OF PREFERRED EMBODIMENTS

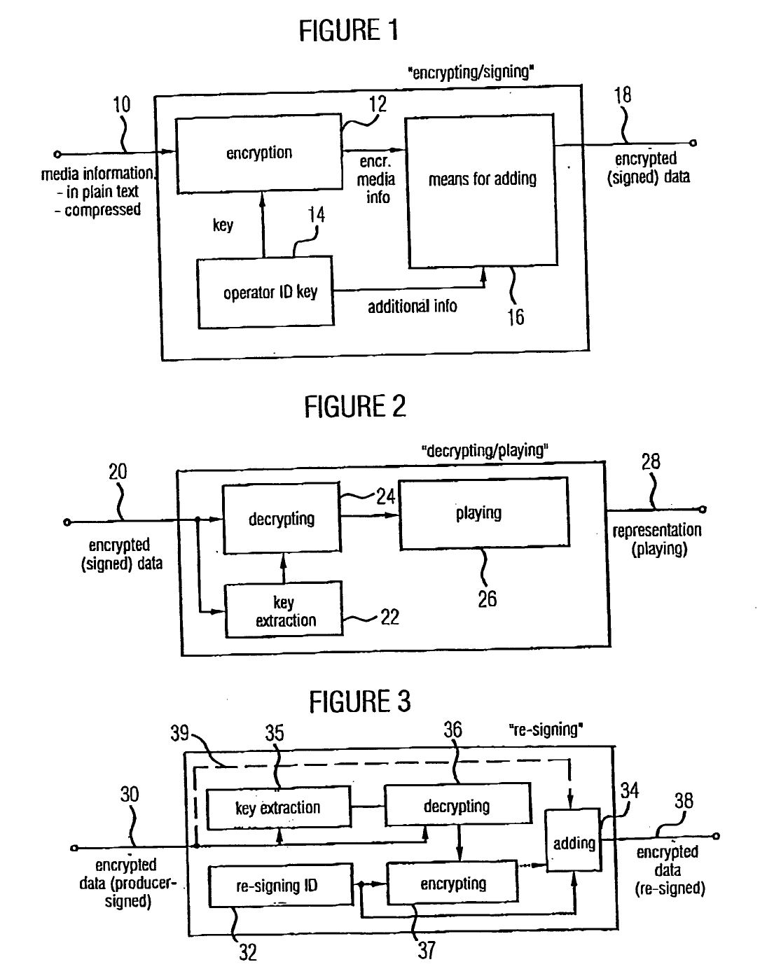

FIG. 1 shows an inventive device for generating encrypted data representing media information. The media information which may be in plain text, or which can be data rate compressed according to a method, such as, for example, MPEG-4, are fed to an input 10 of the inventive device. The media information enters means 12 for encrypting, wherein the means 12 is provided with a key by means 14 for providing additional information which includes an operator identification on the one hand and key information on the other hand. The means 14 for providing which can be embodied as a memory, provides this additional information which allows an operator identification on the one hand and a decryption of the encrypted media information output at the output of the means 12 on the other hand, to means 16 for adding the additional information to the encrypted media information to provide, at an output 18, the encrypted data signed by an operator of the device shown in FIG. 1. It is to be mentioned that the data provided at the output 18 is either encrypted files or continuous stream data.

The plain text media information can, for example, be PCM data which an operator has read out or “ripped” from a CD or DVD in his possession. The media information can additionally be compressed source information, such as, for example, encoded PCM data, wherein a well-known encoding algorithm, such as, for example, MPEG-4, MP3, etc., can be used as the encoding algorithm.

It is also to be pointed out that any media information can be processed with the inventive concept, such as, for example, audio information, video information, text information, graphics, special music information, such as, for example, WAV files, MIDI files, music score files, etc.

Any encryption method, such as, for example, symmetrical encrypting methods (for example Rijndal) or asymmetrical encrypting methods (for example RSA), can be employed as the encrypting method executed by the means 12 for encrypting, wherein a combination of both these concepts is preferred for reasons of computing time. It is particularly preferred to encrypt a symmetrical key for actually encrypting the media information with a key of an asymmetrical encrypting concept and to use, as additional information, both the public key of the asymmetrical method and the symmetrical key encrypted with the corresponding private key. In this case, the added public key also provides the operator identification. In general, the additional information should be formed such that both an identification of the operator and a decryption of the encrypted media information by the additional information can be performed. In particular, it is preferred to select the additional information in such a way that at least a part of the additional information, such as, with the above example, the public key, at the same time represents the operator identification so that a manipulation of the operator identification renders useless the encrypted data at the output 18 of the device of FIG. 1 in the sense that a decryption by means of the information contained in the encrypted data itself is no longer possible.

FIG. 2 shows an inventive device for decrypting encrypted data. At an input 20 of the device shown in FIG. 2 for example, the encrypted and signed data provided at the output 18 of the device shown in FIG. 1 is provided and fed to means 22 for extracting a key and to means 24 for decrypting. The means 22 for extracting is formed to extract, from the encrypted data, decrypting information which is then fed to the means 24 which using the decrypting information from the means 22, decrypts the encrypted media information contained in the encrypted data and feeds it to means 26 for representing or playing. Depending on the embodiment, the means 26 for playing is a speaker (audio information), a monitor (video information), special means for voice or music output, etc. In particular, it is preferred in the embodiment shown in FIG. 2 for the entire system in which the device shown in FIG. 2 is contained, such as, for example, the PC of an operator, not to be able to allow the output of decrypted media information at the output of means 24 as digital data or, put differently, to generate a plain text file. Even if this was performed, however, by unauthorized usage, it would already be an infringement of US law since this is an unauthorized removal of an encryption. Even in this case, a punishment of the offender or a prosecution will be possible if, as will be explained below, a watermark is preferably contained in the plain text data which might be “stolen” at the output of the encrypting means 24, as a second line of defense.

FIG. 3 shows an inventive device for generating re-signed data from encrypted data representing media information. In particular, the encrypted data having been signed by its producer are provided at an input 30 of the device shown in FIG. 3. This encrypted and signed data is the same data present at the output 18 of the device shown in FIG. 1 or at the input 20 of the device shown in FIG. 2. The means for re-signing includes means 32 for providing an identification of the operator of the re-signing device shown in FIG. 3 and means 34 for adding the re-signing operator identification to encrypted media information which is derived from the unencrypted media information by encryption to provide the re-signed encrypted data at an output 38. The re-signed encrypted data at the output 38 in any case contains an identification of the operator of the device shown in FIG. 3 and preferably also the signature of the last producer, i.e. of the data stream provided at the input 30, this feature allowing it to trace the entire path of the media information.

In the embodiment described so far, the device shown in FIG. 3 must only add a new re-signing identification. This will be possible if the key information contained in the encrypted data at the input 30 is independent of the operator information. If, however, there is a dependence between the operator data and the decryption information, i.e. the additional information in the encrypted data, the device shown in FIG. 3 will further include key-extracting means 35 which can be embodied in the same way as the key-extracting means 22 in FIG. 2 and decrypting means 36 which can be embodied in the same way as the means 24 of FIG. 2, and further encrypting means 37 which, in principle, can be embodied as the means 12 of FIG. 1. In this case, the data stream at the input 30, signed by a previous producer, is at first decrypted by the means 36 using the decrypting information provided by the key-extracting means 35 and encrypted again using the new re-signing identification provided by the means 32 using the identification of the operator of the re-signing device. In this case a broken connection 39 in FIG. 3 will not be present.

Subsequently, a preferred embodiment of a file format for the encrypted and signed data will be discussed. If the encrypted and signed data is present as a file, the file will contain a header having a format indication (40). This header may be followed by a certificate of the operator or a public key associated to this operator (42). The entry 42 into the file thus ensures the producer identification. The area 42 can be followed by an area 44 in which a symmetrical key encrypted by the public key of the area 42 is contained, which is used to decrypt encrypted media information in an area 46. The areas 42 and 44 thus represent the additional information formed such that both an identification of the operator (by the area 42) and a decryption of the encrypted media information (by the areas 42 and 44) can be performed.

An overview of the possibilities of the inventive concept, which in FIG. 5 is referred to as “DRM system 50” and, in a preferred form contains all the devices shown in FIGS. 1 to 3 and further features, will be illustrated subsequently referring to FIG. 5. On the input side, plain text media information or compressed media information may be fed to the DRM system (51a). Additionally, the DRM system 50 in a preferred embodiment of the present invention, is formed to obtain as an input signal the signed and encrypted data (51b) corresponding for example to the data at the output 18 of FIG. 1. Furthermore, the DRM system 50, in a preferred embodiment of the present invention, is formed to obtain, as an input quantity, local archive data (51c) which, as will be discussed below, is “hard”-encrypted using a machine-depending key such that the local archive data do not contain decrypting information nor an operator signature.

In addition, in a preferred embodiment of the present invention, a data format having signed and additionally “hard”-encrypted data can be provided to the DRM system 50 shown in FIG. 5, wherein this data format is also referred to as the “AtoB” format (51d). The “AtoB” format is characterized by the fact that the contents has been generated by a user A such that it can only be decrypted by B.

In another embodiment, the inventive DRM system 50 may also be provided with a file having protected media information by a media provider 52, the media information typically not being signed by the media provider 52 which can, for example, be a proprietor of the rights of the media information or a licensed publisher. The media information transferred from the media provider 52 to the DRM system 50 is cryptographically protected media information. Thus, it is made possible for the DRM system to operate in a publish mode to support or perform a media distribution of the media provider 52. This is also referred to a super distribution.

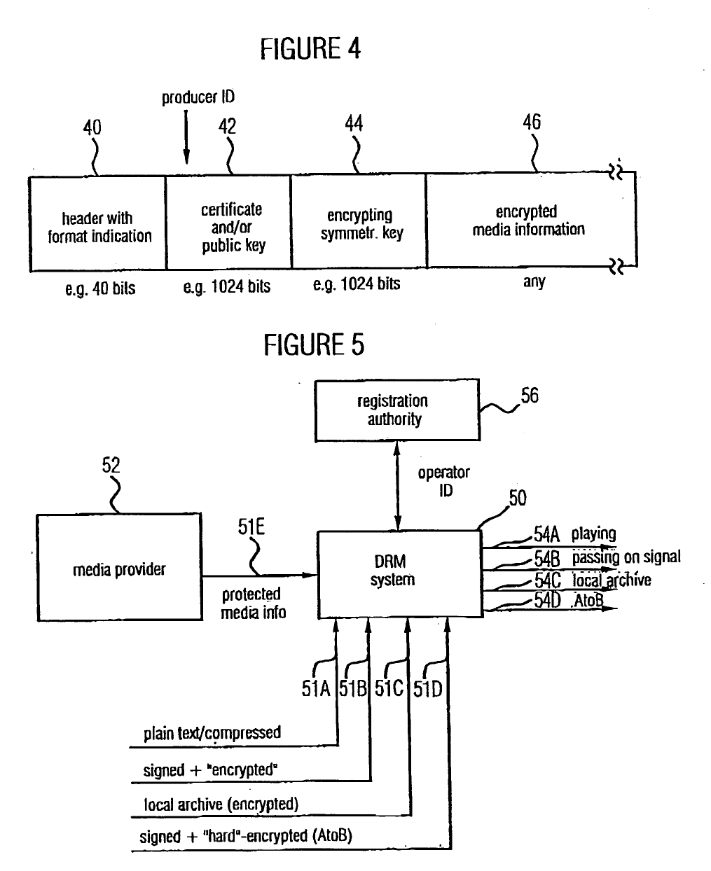

On the output side, the inventive DRM system 50 is able to play (54a) data formats obtained via the input 51a to 51d, to generate (54b) a signed data format, to generate (54c) a local data format to set up a local archive or to generate (54d) signed and “hard”-encrypted data at an output, i.e. to write an AtoB format. The format indication, i.e. whether the format fed to the DRM system 50 is plain text data or compressed data (51a), whether it is signed and encrypted data (51b), whether there is local data (51c), whether there is an AtoB format (51d) or whether there is a publish format (51e), is contained in the header of FIG. 4. The inventive DRM system 50 illustrated in FIG. 5, i.e. a header examination is performed, before each actual action to take certain actions depending on the data format.

If inconsistencies are already discovered in the header 40 of FIG. 4, a processing of the data format will not take place. The preferred DRM system shown in FIG. 5 does not have, however, an output for plain text data or compressed data in a digital form. This makes obvious that the inventive DRM concept, as has already been explained, will result in plain text data not to be generated or provided at any point, except for CDs or other sound carriers containing plain text data (PCM data). As has already been explained, the inventive DRM system also contains a data compression module which, due to its high data rate compression, allows a digital storage in a conventional way. If such a compression module cannot be obtained in a plain text form, but is only available in a form embedded in a DRM system, it can be expected that a processing of data compressed in this compression format will not take place at all. A stimulus for the operator may be that this compression format on the one hand provides high data compression factors and on the other hand provides good quality and additionally is distributed for free or at very low cost, wherein the actual cost for the new data format, such as, for example, MPEG-4, can be saved easily by stemming illegal pirate copying.

It is to be mentioned at this point that plain text data, in the sense of the present document, may be encoded or uncoded, while encrypted data is generated from the plain text data by a cryptographic algorithm.

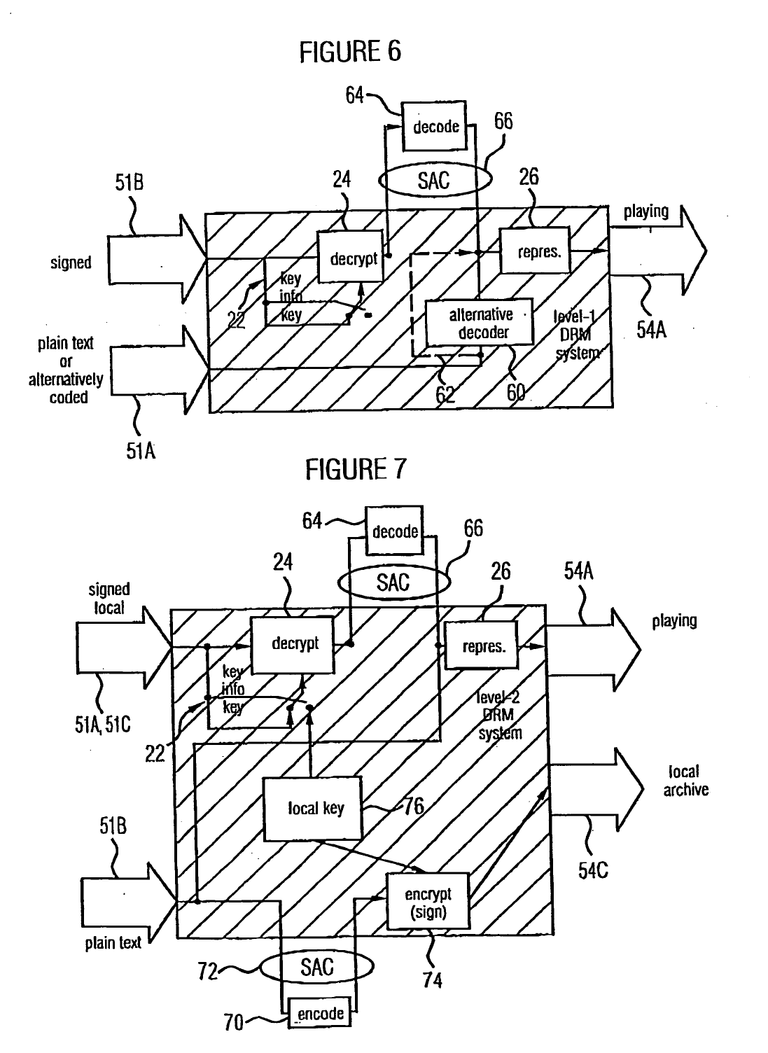

Subsequently, referring to FIGS. 6, 7, 8, 9 and 10, five different embodiments of preferred DRM systems will be discussed. The same reference numerals refer to the same elements and functionalities throughout the figures.

The level-1 DRM system shown in FIG. 6 includes, as a main functionality, playing the signed format and additionally includes, as an addition for the operator, a plain text input or an input for encoded media information (51a) which is encoded alternatively to the signed and encrypted data at the input (51b). Alternatively encoded data is fed to an alternative decoder 60 to be decoded before its representation/playing (26). If plain text data is fed at the input (51a), the alternative decoder will be bypassed (62). Subsequently, it is always assumed that the media information is compressed media information and preferably compressed by means of MPEG-4. Thus, a decoder 64 connected to the DRM system via a safe channel (SAC 66; SAC=secure authenticated channel) is connected between the decrypting means 24 and the representing means 26. The decoder 64 can either be part of the DRM system or can additionally be switched in as an external module. In this case, the SAC 66 is an external interface for the DRM system, ensuring that only special decoders 64 will be served, i.e. decoders which are certified in that they do not allow a plain text output as a digital file.

PCM data or MP3-encoded data can be fed as plain text or alternatively encoded input data, wherein in this case the alternative decoder is an MP3 decoder.

In FIG. 7, a level-2 DRM system is shown, which additionally to the DRM system shown in FIG. 6, allows generating a local archive (54c) on the one hand and feeding local archive data (51c). The level-2 DRM system shown in FIG. 7 thus introduces the local format serving to allow an operator to locally produce MPEG-4 data and additionally only be able to play it locally. For this, plain text data at the input (51b) is encoded by an MPEG-4 encoder 70 which can be integrated or interfaced via an SAC 72.

The encoded data is then fed to encrypting means 74 which encrypts the encoded data using a local key 76 and feeds it to a local archive output (54c). The locally encrypted data, however, does not include decrypting information. For decryption, the local archive data is thus fed to decrypting means 24 which, however, does not try to extract key information but switches to the local key 76 when a local format is recognized (40 of FIG. 4).

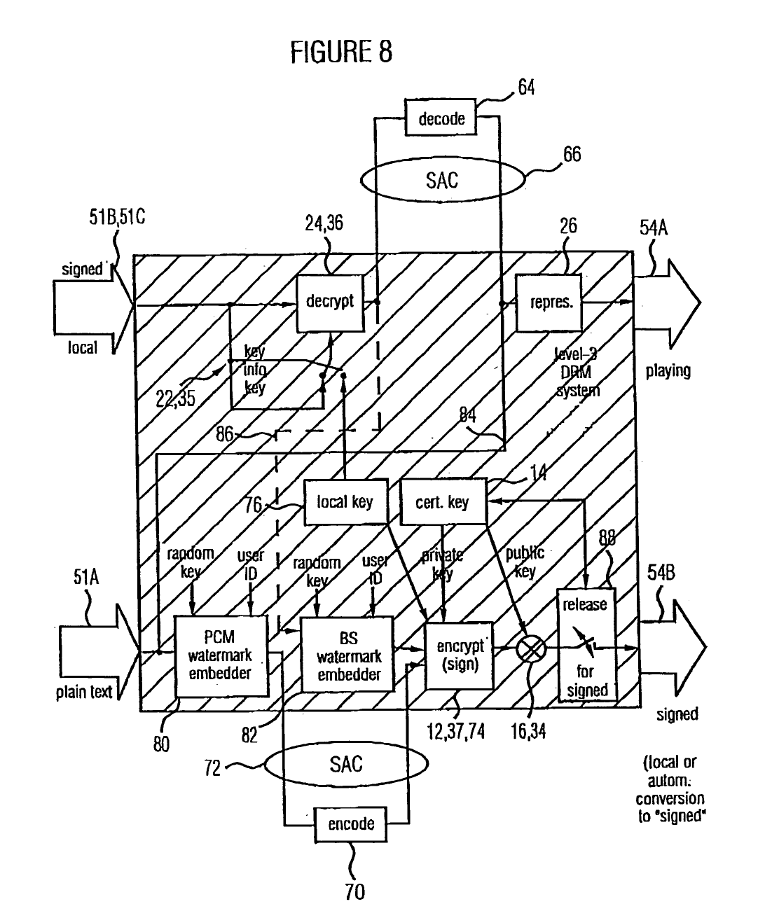

The level-2 DRM system is intended for an operator who wants to look at the new system and, in particular, the new encoder/decoder (70/74), but who has not (yet) registered to generate (FIG. 1) or re-sign (FIG. 3) encrypted and signed data. The operator of the level-2 DRM system can thus not yet generate or pass on legally encrypted and signed data; he can, however, already examine the functionality of the new encoding/decoding concept and then may decide for a full version. The operator can, however, already play work obtained by friends or distributors in a signed format, since the level-1 DRM system of FIG. 6 is contained in the level-2 DRM system of FIG. 7. The operator can furthermore generate a local archive (54c) of his own music data, i.e., for example, a digital archive of his own CDs, which he can, however, only play on his own apparatus, such as, for example, his PC, using the local key 76. As will be discussed referring to FIG. 8, the level-2 DRM system, after registering the operator, becomes a level-3 DRM system so that encrypted and signed data can be generated as well, not depending on whether the input data is plain text data or encrypted, but unsigned local data. The local key 76 is, for example, as will be discussed below, derived from a machine-dependent identification, such as, for example, the serial number of a PC, etc.

Subsequently, the level-3 DRM system will be described referring to FIG. 3, which, apart from the functionalities of the DRM systems of FIGS. 6 and 7, i.e. the functionality of playing signed and encrypted data and the functionality of generating a local archive, also has the functionality to generate the signed format, for example on the basis of plain text information (device of FIG. 1) or to convert a signed data format to a re-signed data format (device of FIG. 3).

Means 14 for providing a certified key is essential for the device shown in FIG. 8, to generate encrypted (and thus signed) data on the one hand or to re-sign data signed by a first operator. The certified key is preferably provided by the registration authority 56 (FIG. 5) representing a neutral authority by means of which the identity of the operator of the device shown in FIG. 8 can be determined with the help of the certified key. The public key entered in block 42 of FIG. 4 thus represents the operator identification information.

The preferred functionality of embedding a watermark either on the PCM level or the bitstream level is also illustrated in FIG. 8. The embedding of the watermark thus is performed by a PCM watermark embedder 80 or a bitstream watermark embedder 82.

PCM watermark embedders are, for example, illustrated in the German patent DE 196 40 814 C1. A PCM watermark embedder, like a bitstream watermark embedder as well, is based on providing a payload, like in this case an operator ID or user ID, with a spread sequence to subsequently weight the spreaded payload signal such that, when combined with the audio data which are to be provided with a watermark, it is inaudible, i.e. below the psycho-acoustic masking threshold as far as energy is concerned. The—optional—watermark embedding can, as has been explained, take place either on a time level (block 80) or on a bitstream level (block 82), wherein only a partial unwrapping and not a complete decoding of the encoded data is required. If the watermark embedding is performed on the time level, the output signal of the decoder 64 will be fed to the PCM watermark embedder 80 via a transmission line 84. If, however, a bitstream watermarking is performed, the input signal to the decoder 64, i.e. the encoded source information at the output of the decrypting means 24, 36, will be fed into the bitstream watermark embedder via another transmission line 86. In this case, the bitstream watermark embedder 82 already provides the media information to be encrypted so that in the case of bitstream watermarking the encoder 70 is no longer required.

It is to be mentioned that the watermark will not be evaluated in normal usage. If, however, the protection mechanisms of the inventive concept are bypassed illegally and if the raw data is further processed, the impressed inaudible watermark or, in video data, the invisible watermark or, in text data, the watermark entered by steganographic methods, can be evaluated for forensic purposes to draw conclusions with regard to the illegal distributor.

Thus, it is preferred to embed the watermark itself, i.e. the payload information which either corresponds to the user ID or, when the user ID is too long or the direct transmission of the user identification is not desired for reasons of protecting the private sphere, is for example derived from the user ID by means of a hash processing, with a key referred to as “random key” in FIG. 8. Thus, another—encrypted—pseudo random sequence is used for spreading. This has the advantage that, compared to encrypting the payload by encrypting the spread sequence, fewer payload interferences or no interferences at all occur.

This has the advantage that the watermark is protected better. This in turn has the advantage that several watermarks of subsequent operators can be entered when the spread sequences derived from the random keys are orthogonal to each other. This concept corresponds to the well-known CDMA method in which several communication channels are contained in a frequency channel, which each occupy the same frequency band but which can, however, be separated with the help of a correlator in a watermark extractor. Furthermore, a modification of the watermark increases the anonymity of the legal operator, but allows lifting and, if applicable, punishing the illegal operator from anonymity.

In particular, two methods for generating these watermark keys are preferred. In the first method for generating these watermark keys, another random key having a variable length is used, which can be adopted to the decoding times with further technology progress. This ensures that when testing all possible keys for extracting a watermark for forensic purposes a certain amount of work has to be done, and thus the watermark ID is practically safe and anonymous since it can only be read with considerable expenditure since nobody knows the key. The decoding for forensic purposes thus takes place by trying all possible keys. This is not problematic since, when decoding for forensic purposes, there is sufficient time since usually the number of illegal distributors will be adjusted to the respective current computer technology.

The alternative method for generating watermark keys is the existence of a set of different keys derived from the operator ID in a well-known manner and the fact that one of these possible watermark keys is used in the watermark encryption. Thus, the proof of identification can only be performed for an operator to be checked with moderate expenditure.

It can be seen from FIG. 8 that the level-3 DRM system includes all the functionalities, i.e. to play signed data, local data and plain text data, to generate signed data from plain text data and to generate re-signed data from signed data. As is implied in FIG. 8, a functionality is further preferred where, when local data is fed on the input side by an operator to play it, a conversion into the encrypted and signed format can be performed. This is possible because the operator of the system shown in FIG. 8 has already registered since he is in possession of the certified key 14.

As has already been illustrated referring to the embodiment shown in FIG. 7, the local data format for generating an encrypted local archive is of advantage in that an introductory version is so to speak provided for a new encoding method 70 and decoding method 64, respectively. For reasons of economy it is preferred to provide enabling or releasing means 88 in the level-3 DRM system shown in FIG. 8, which allows outputting a signed data format when the operator has obtained the certified key 14 for example from the registering authority 56 in FIG. 5. If the operator has not yet obtained the certified key, the enabling or releasing means 88 is active to only allow outputting local data but not signed data. Thus, it is possible, when the operator has registered and obtained a certified key, to add the functionality shown in FIG. 8 to the functionality shown in FIG. 7 simply by activating the enable or release means without the operation requiring new software or new hardware. Depending on the embodiment, full versions can be distributed, in which, however, a releasing means 88 ensures that the full functionality can only be utilized by the operator when he has registered, i.e. when he has obtained the certified key 14.

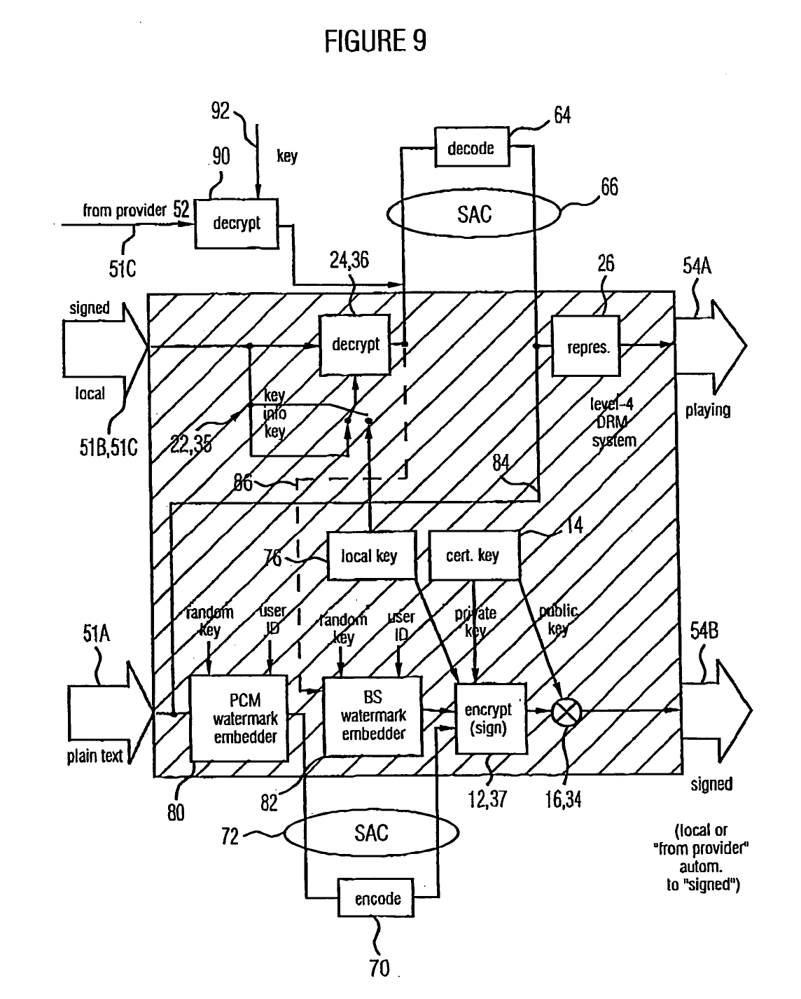

Subsequently, an extension of the inventive DRM system to a so-called distribution format will be illustrated referring to FIG. 9 (level-4 DRM system). For this, an operator of a DRM system receives protected but unsigned media information from the media provider 52 via an input (51e). In order to decrypt this protected, i.e. encrypted media information not containing encrypting information, another decrypting means 90 is provided, to which a key 92 typically transmitted to the operator of the DRM system via a safe channel must be provided. An asymmetrical encrypting method in combination with a symmetrical encrypting method is preferred here. The protected media information (51e) provided by the provider 52 is also encrypted with a symmetrical key which in an embodiment of the present invention is not contained in the protected media information. This key is provided externally (92).

An asymmetrical encrypting method can also be used here with advantage. The operator of the device shown in FIG. 9 provides his public key to the media provider 52 who then encrypts the symmetrical key for decrypting the media information with this public key and adds this encrypted symmetrical key to the media information. The operator of the device shown in FIG. 9 can then decrypt the encrypted symmetrical key contained in the data stream using his private key (92) to then decrypt the unsigned information obtained from the media provider by the means 90. The decrypted media information is then, when it is encoded data, fed to the decoder 64 and then output by the representing means 26 in the form represented, but not as a file.

In order to generate a signed data format from the protected media information provided by the provider, the output data of the decrypting means is processed as usual. The level-4 DRM system shown in FIG. 9 thus allows a super distribution or a distribution via non-personalized media, such as, for example, CDs.

The DRM system shown in FIG. 9 further has the functionality, in case an operator of it still has local data, to automatically or non-automatically convert it to signed data depending on the embodiment.

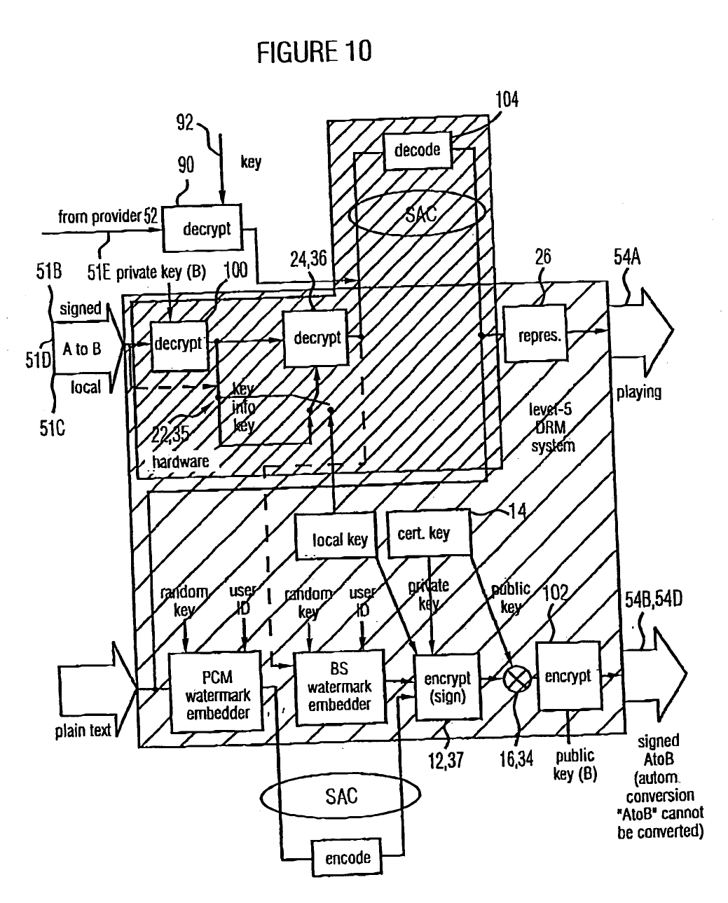

Another embodiment of the inventive concept, which, for reasons of simplicity, will be referred to as level-5 DRM system will be illustrated subsequently referring to FIG. 10. In order to allow passing on a signed and encrypted file to only a single user person, the system shown in FIG. 10 is able to additionally encrypt with a personal key and to transmit it to the recipient. This point-to-point format is also referred to as the AtoB format. If the system shown in FIG. 10 is the recipient B, the system on the input side will receive an AtoB data stream (51d) encrypted with the public key of the system B. Another decrypting means 100 is provided for decrypting, to which the private key (B) of B is fed to decrypt the AtoB format and then to continue processing as is illustrated in the remaining Figs. If the device shown in FIG. 10 is a producer of the AtoB format, another encrypting means 102 after the adding means 16, 34 will be provided to encrypt the signed and encrypted data stream with a public key of the recipient B obtained from a recipient to output a data stream in the AtoB format.

It is to be pointed out that for encrypting and decrypting in the means 102 and 100, respectively, an asymmetrical encrypting method need not be employed. This is, however, preferred for reasons of economy. Furthermore, the device shown in FIG. 10 is formed to prevent a conversion of the hard-encrypted AtoB format into a freely encrypted and signed format. The device shown in FIG. 10 only allows a representation of the media information but not a change to a signed/encrypted format.

In this respect, the AtoB format is a way of passing on signed data to persons who are not 100 percent trustworthy. These recipients cannot pass on the contents in the sense of conventional restrictive DRM systems. An exception of playing back to a file is when, for purposes of distribution, it has been signed for B and sent to B. When the signer and the recipient are identical, the signed format can be written as a file. As has already been discussed, a private key is required on each player for playing the AtoB format. This private key must be fed to the decrypting means 100. In order to prevent bypassing the AtoB format, it is preferred to embody the area of the DRM system (104) illustrated in dark colors in FIG. 10 in hardware.

For transmitting the private key to a recipient, this key is encrypted and transmitted to corresponding players of the recipient so that the AtoB format can be converted into a signed format for playing, which can then be played —without a possibility for storage. A protected method (SAC=secure authenticated channel) is also preferred for this transmission.

In principal, only one private key should be present on each apparatus, since several private keys make possible playing contents belonging to several private persons. On the other hand, the private operator should be interchangeable, which is obtained by loading a new key and erasing the old one. The complexity of changing for which an artificial time limit of one hour or one day may be imposed when updating, is thought to be sufficient to prevent gross misuse. Personalizing the second apparatus, however, is simple.

With regard to members of a shopping club, it is preferred to install one or several additional club keys having a validity with limited time, such as, for example, one year, on the private apparatus so that contents obtained from the club can be played in the AtoB format. There are many keys for this in the apparatus but not in the media part itself because the keys would then be available to anyone. These many keys are required to keep playable a collected library of personalized files.

Depending on the circumstances, the inventive method illustrated in FIGS. 1-3 and particularly in FIGS. 6-10 can be implemented in either hardware or software. The implementation can be on a digital storage medium, in particular a floppy disc or CD having control signals which can be read out electronically, which can in this way cooperate with a programmable computer system such that the corresponding method will be executed. In general, the invention also includes a computer program product having a program code, stored on a machine-readable carrier, for performing the inventive method when the computer program product runs on a computer. Put differently, the present invention also relates to a computer program having a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A device for generating encrypted data representing media information, comprising:
a provider for providing an operator identification by means of which an operator of the device can be identified;
an encryptor for encrypting the media information with an encrypting key to generate encrypted media information; and
an adder for adding additional information to the encrypted media information to generate the encrypted data, the additional information including the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text or the key in plain text.

2. The device according to claim 1, further comprising:
an encoder for encoding source information to obtain media information which is a data rate compressed version of the source information.

3. The device according to claim 1,
wherein the encryptor for encrypting is configured to use the operator identification or information derived from the operator identification as the encrypting key, and wherein the adder for adding is configured to only add, as additional information, decrypting information additionally allowing an identification of the operator.

4. The device according to claim 1,
wherein the encryptor for encrypting is configured to execute a symmetrical encrypting method with a symmetrical encrypting key,
wherein further an encryptor for encrypting the symmetrical encrypting key with a private key of an asymmetrical encrypting method is provided to obtain the encrypting key in an encrypted form, and
wherein the adder for adding is configured to use, as additional information, the encrypting key in an encrypted form and a public key belonging to the private key as the key in plain text.

5. The device according to claim 1, further comprising:
an embedder for embedding a watermark, wherein the watermark corresponds to the operator identification or is derived from the operator identification.

6. The device according to claim 5,
wherein the embedder for embedding a watermark is configured to embed the watermark into the media information.

7. The device according to claim 5,
wherein the media information is a data rate compressed version of source information, wherein the inserter for inserting a watermark is configured to embed the watermark into the source information before compressing same.

8. The device according to claim 5,
wherein the media information is a data rate compressed version of source information, wherein the inserter for inserting a watermark is configured to embed the watermark into a partially decoded version of the media information.

9. The device according to claim 5,
wherein the embedder for embedding a watermark is configured to encrypt the watermark with a watermark key before embedding same.

10. The device according to claim 9,
wherein the embedder for embedding a watermark is configured to randomly select the watermark key or to select same from a set of different keys derived from the operator identification.

11. The device according to claim 1,
wherein the media information is a data rate compressed version of source information which can be generated by an encoder,
wherein the device additionally comprises:
an interfacer for interfacing an encoder, the interfacer being configured to examine a connected encoder with regard to a safety feature to only perform a communication with the encoder when the encoder meets the safety feature which is that the encoder prevents the output of compressed source information.

12. The device according to claim 1,
wherein the provider for providing is configured to only provide an operator identification assigned to the operator of the device by a registration authority.

13. The device according to claim 1, further comprising:
a releaser for releasing an output of the encrypted data only when the provider for providing has an externally assigned operator identification; and
a local archiver for encrypting media information with a local key unambiguously associated to the device and for outputting local data not having the local key so that the local data can only be decrypted by the device itself,
wherein the local archiver can be operated independently of a release by the releaser.

14. The device according to claim 13,
wherein the local archiver is configured to derive the local key from a machine identification, a network identification or a time stamp, which is associated to a system into which the device is embedded.

15. The device according to claim 1, wherein the media information is encrypted by a media provider and does not comprise a signature of the media provider, the device further comprising:
a decryptor for decrypting the encrypted media information using a key not contained in the encrypted media information, wherein the decrypter for decrypting is upstream of the encrypter for encrypting.

16. A method for generating encrypted data representing media information, comprising the following steps:
providing the operator identification by means of which an operator of the device can be identified;
encrypting the media information with an encrypting key to generate encrypted media information; and
adding additional information to the encrypted media information to generate the encrypted data, the additional information including the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text of the key in plain text.

17. A device for decrypting encrypted data representing media information, the encrypted data comprising encrypted media information and additional information, wherein the additional information include the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text of the key in plain text, comprising:
an extractor for extracting the encrypting key in plain text of the key in plain text as the decrypting key from the encrypted data;
a decryptor for decrypting the encrypted media information using the decrypting key to obtain decrypted media information; and
a player for playing the media information, wherein the device is further configured to prevent an output of the decrypted media information as digital data.

18. The device according to claim 17,
wherein the encrypted media information is encrypted using a symmetrical key, wherein the symmetrical key is encrypted using a private key of a producer, and wherein a public key of the producer belonging to the private key is the key in plain text,
wherein the extractor for extracting is configured to extract the public key and an encrypted symmetrical key from the additional information, and
wherein the decrypter is configured to decrypt the symmetrical key using the public key and to decrypt the encrypted media information using the decrypted symmetrical key.

19. The device according to claim 17,
wherein the media information is a data rate compressed version of source information, and
wherein the representer for representing comprises a decoder for decoding the decrypted media information to obtain the source information,
wherein the representer for representing is configured to prevent storage of the source information in a digital form.

20. The device according to claim 17, wherein the media information is a data rate compressed version of source information which can be decoded by a decoder, the device further comprising:
an interfacer for interfacing a decoder, the interfacer being configured to examine a connected decoder with regard to a safety feature to only perform a communication with the decoder when the decoder meets the safety feature, which is that the decoder prevents an output of decoded source information in a digital form.

21. The device according to claim 17, further comprising:
a representer for representing unencrypted media information.

22. The device according to claim 17, further comprising:
a local representer for decrypting local data not comprising decrypting information as additional information, using a key locally associated to the device and for representing the decrypted local data.

23. A method for decrypting encrypted data representing media information, the encrypted data comprising encrypted media information and additional information, the additional information including the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text of the key in plain text, the method comprising the following steps:
extracting the encrypting key in plain text or the key in plain text as the decrypting key from the encrypted data;
decrypting the encrypted media information using the decrypting key to obtain decrypted media information;
playing the media information; and
preventing an output of the decrypted media information as digital data.

24. A device for generating re-signed data from encrypted data already signed, representing media information, the encrypted data comprising encrypted media information and additional information, wherein the additional information includes the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text or the key in plain text, comprising:
a provider for providing a re-signing operator identification of an operator of the device for generating the re-signed data;
an extractor for extracting the encrypting key in plain text or the key in plain text as decrypting information from the encrypted data;
a decrypter for decrypting the media information using the decrypting information to obtain decrypted media information;
an encrypter for encrypting again the decrypted media information using a new encrypting key corresponding to the re-signing operator identification or being derived therefrom in order to obtain media information encrypted again; and
an adder for adding the re-signing operator identification to the media information encrypted again in order to obtain the re-signed data.

25. The device according to claim 24, wherein the additional information comprises decrypting information at the same time representing the identity of the producer, the device further comprising:
an extractor for extracting the decrypting information from the encrypted data;
a decrypter for decrypting the encrypted data using the decrypting information; and
an encrypter for encrypting the decrypted data using encrypting information corresponding to the re-signing operator identification or being derived therefrom in order to obtain the encrypted media information.

26. The device according to claim 25,
wherein the decrypting information comprises a public key of the producer and a symmetrical key encrypted with a private key of the producer, by the usage of which the media information is encrypted,
wherein the decrypter for decrypting is configured to decrypt the encrypted symmetrical key at first using the public key and to subsequently decrypt the encrypted media information using the symmetrical key, and
wherein the encrypter for encrypting is configured to encrypt at first the media information using a symmetrical key and to subsequently encrypt the symmetrical key using a private key which is associated to an operator of the device for generating re-signed data, wherein the re-signing operator identification comprises the public key of the operator of the device for generating re-signed data or is derived therefrom.

27. The device according to claim 24, further comprising:
an embedder for embedding a watermark, the watermark corresponding to the re-signing operator identification or being derived therefrom.

28. The device according to claim 27, wherein the embedder for embedding a watermark is configured to embed the watermark into the media information.

29. The device according to claim 26, wherein the media information is a data rate compressed version of source information, the embedder for embedding a watermark being configured to embed the watermark into the source information before compressing same.

30. The device according to claim 26, wherein the media information is a data rate compressed version of source information, the embedder for embedding a watermark being configured to embed the watermark into a partially decoded version of the media information.

31. The device according to claim 27,
wherein the embedder for embedding a watermark is configured to add the watermark which is based on the re-signing operator identification, to one or several watermarks already embedded.

32. The device according to claim 31,
wherein the embedder for embedding a watermark is configured to obtain a quality deterioration when representing the media information with every further watermark.

33. The device according to claim 26,
wherein the embedder for embedding a watermark is configured to encrypt the watermark with a watermark key before embedding same.

34. The device according to claim 33, wherein the embedder for embedding a watermark is configured to randomly select the watermark key or to select same from a set of different keys derived from the re-signing operator identification.

35. The device according to claim 24, further comprising:
a releaser for only releasing an output of the encrypted data when the provider for providing has an externally assigned operator identification; and
a local archiver for encrypting media information with a local key unambiguously associated to the device and for outputting local data not having the local key so that the local data can only be decrypted by the device itself,
wherein the local archiver can be operated independently of a release by the releaser.

36. The device according to claim 24, further comprising:
an extractor for extracting a decrypting key from the encrypted data;
a decrypter for decrypting the encrypted media information using the decrypting key in order to obtain decrypted media information; and
a player for playing the media information.

37. The device according to claim 24,
wherein further a preventer for preventing an output of plain text media information, plain text source information or data rate compressed source information for the purpose of storage in a digital form is provided.

38. The device according to claim 26, further comprising:
an encrypter for encrypting the re-signed data for one exclusive user such that only the exclusive user will be able to play the media information.

39. A method for generating re-signed data from encrypted data already signed, representing media information, the encrypted data comprising encrypted media information and additional information, wherein the additional information includes the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text or the key in plain text, comprising the following steps:
providing a re-signing operator identification of an operator of the device for generating re-signed data;
extracting the encrypting key in plain text of the key in plain text as decrypting information from the encrypted data;
decrypting the media information using the decrypting information to obtain decrypted media information;
encrypting again the decrypted media information using a new encrypting key corresponding to the re-signing operator identification or being derived from same in order to obtain again encrypted media information; and
adding the re-signing operator identification to the media information encrypted again in order to obtain the re-signed data.

40. A computer program having a program code for performing a method for generating encrypted data representing media information, the method comprising the following steps: providing the operator identification by means of which an operator of the device can be identified; encrypting the media information with an encrypting key to generate encrypted media information; and adding additional information to the encrypted media information to generate the encrypted data, the additional information including the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text of the key in plain text, when the computer program runs on a computer.

41. A computer program having a program code for performing a method for decrypting encrypted data representing media information, the encrypted data comprising encrypted media information and additional information, the additional information including the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text of the key in plain text, the method comprising the following steps: extracting the encrypting key in plain text or the key in plain text as the decrypting key from the encrypted data; decrypting the encrypted media information using the decrypting key to obtain decrypted media information; playing the media information; and preventing an output of the decrypted media information as digital data, when the computer program runs on a computer.

42. A computer program having a program code for performing a method for generating re-signed data from encrypted data already signed, representing media information, the encrypted data comprising encrypted media information and additional information, wherein the additional information includes the encrypting key in plain text or the encrypting key in an encrypted form and a key in plain text for decrypting the encrypting key, wherein the encrypting key in plain text or the key in plain text represents the operator identification or is derived from the operator identification such that the operator can be identified unambiguously with the help of the encrypting key in plain text or the key in plain text, the method comprising the following steps: providing a re-signing operator identification of an operator of the device for generating re-signed data; extracting the encrypting key in plain text of the key in plain text as decrypting information from the encrypted data; decrypting the media information using the decrypting information to obtain decrypted media information; encrypting again the decrypted media information using a new encrypting key corresponding to the re-signing operator identification or being derived from same in order to obtain again encrypted media information; and adding the re-signing operator identification to the media information encrypted again in order to obtain the re-signed data, when the computer program runs on a computer.
